(19) United States
(12) Patent Application Publication
(10) Pub. No.: US 2002/0108401 A1
(43) Pub. Date: Aug. 15, 2002

(54) Slumped bottle and label apparatus and method

(76) Inventor: Eric L. Horne, Brunswick, ME (US)

Correspondence Address: Eric L. Horne, 24A Cumberland Street, Brunswick, ME, 04011, US

(21) Appl. No.: 09/782,452

(22) Filed: Feb. 13, 2001

(51) Int. Cl. C03B 23/00

(52) U.S. Cl. 65/102

(57) ABSTRACT

The invention relates to a method of making a collectible souvenir from a melted wine bottle that can be used as a wall hanging, a trivet, a cheese tray or a spoon rest. The method comprising the steps of melting (or “slumping”) a wine bottle and gluing a support such as a self-leveling hanger to a back surface of the slumped bottle, affixing a vineyard's label to the front of the bottle, and treating the vineyard label with a spray or brushed acrylic to protect it from deterioration. By featuring a vineyard's label, the invention makes available to wine enthusiasts a unique and useful gift item that commemorates a vineyard's brand name and identity.

### BACKGROUND OF THE INVENTION

The present invention relates to a method of making products such as gift items from melted wine bottles that incorporate chemically treated labels on one side and wall hangers on the reverse side.

As tourist visitation to vineyards and wineries continues to increase, vineyard owners have sought ways to satisfy their gift store customers with unique items that feature the vineyard's logo and, when possible, would provide the actual labels that the vineyards put on the wines they produce. Although novelty items such as cheese trays and wind chimes have been fabricated from melted bottles, such products have not enabled the buyer to associate the item itself with the brand identity of the particular vineyard or winery where it was purchased. Thus, vineyard owners selling such gift items lose an important opportunity to heighten brand awareness and to deepen brand loyalty among their customers.

### BRIEF SUMMARY OF THE INVENTION

It is, therefore, an object of the invention to provide a collectible or gift item which will meet the need of vineyard owners to develop brand awareness and loyalty among customers. This objective is met by the present invention, which incorporates a melted wine bottle having flat front and back surfaces and which features a label from a particular vineyard on its front surface. The label preferably is an actual label used by the vineyard and which, therefore, identifies a particular brand of wine. The melted wine bottle incorporates a self-leveling wall hanger affixed to its back surface and includes a chemical treatment such as a sprayed or brushed acrylic protective treatment for the label so it will not deteriorate with use, allowing the bottle to be hung on the wall for display and/or used as a trivet, cheese tray, spoon rest, or the like. The hanger has a piece of felt or the like affixed to the back to prevent the hanger from scratching whatever surface it is placed on or against.

In accordance with the method of the present invention, a suitable wine bottle is cleaned and placed on its side in a standard kiln for heating. The kiln is fired to a temperature of “Cone 016”, for example, at which time the kiln shuts off automatically. During the heating process, the glass bottle is heated to a temperature at which gravity causes it to collapse, or “slump” to a substantially flat configuration while retaining an outline shape which is recognizable as a wine bottle. The bottle is allowed to cool for approximately seven hours, and is then removed from the kiln and cleaned. Thereafter, a conventional wine bottle label depicting any desired brand or type of wine is affixed to a front surface of the slumped bottle, the label is coated with a protective layer, and a suitable bottle support, such as a wall hanger, is affixed to the rear surface of the slumped bottle.

### BRIEF DESCRIPTION OF THE DRAWINGS

The foregoing, and additional objects, features, and advantages of the present invention will become evident to those with skill in the art from the following detailed description of a preferred embodiment thereof, taken in conjunction with the accompanying drawings, in which.

FIG. 1 is a top plan view of a slumped wine bottle carrying a label on a front surface thereof, in accordance with the present invention;

FIG. 2 is a side view taken from the left hand edge of the bottle of FIG. 1;

FIG. 3 is a plan view of the back side of the bottle of FIG. 1;

FIG. 4 is a top view of the slumped bottle of FIG. 1, shaded to illustrate the shape of the bottle;

FIG. 5 is a top plan view of a slumped wine bottle following removal from a heating oven;

FIG. 6 illustrates the method step of applying a label to the flat front surface of the slumped wine bottle of FIG. 5;

FIG. 7 illustrates the step of applying a protective coating to the wine label of FIG. 6;

FIG. 8 illustrates the back surface of a wine bottle following removal from a heating oven;

FIG. 9 illustrates the step of applying a self-leveling hanger to the back surface of FIG. 8; and

FIG. 10 illustrates the step of adhering a protective layer such as felt to the hanger illustrated in FIG. 9.

### DETAILED DESCRIPTION OF THE INVENTION

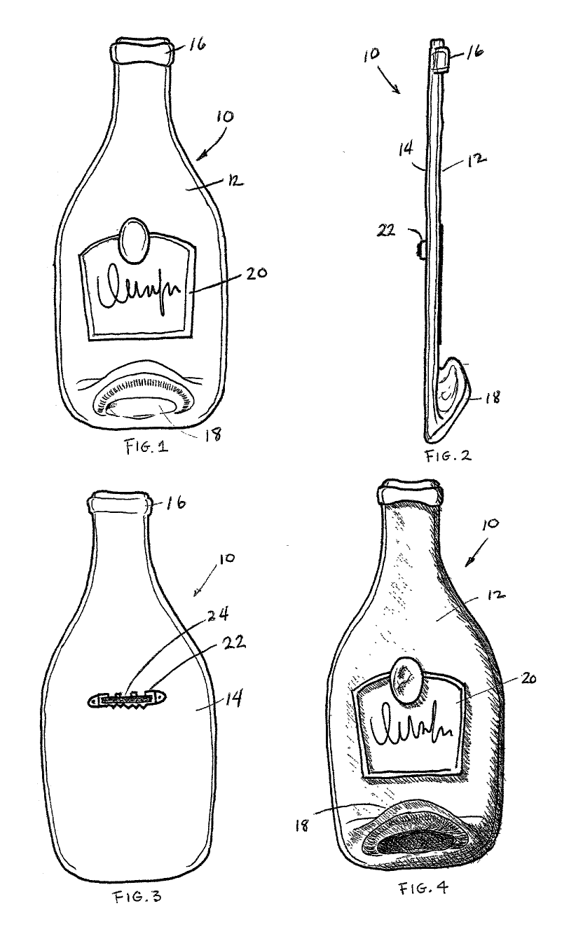

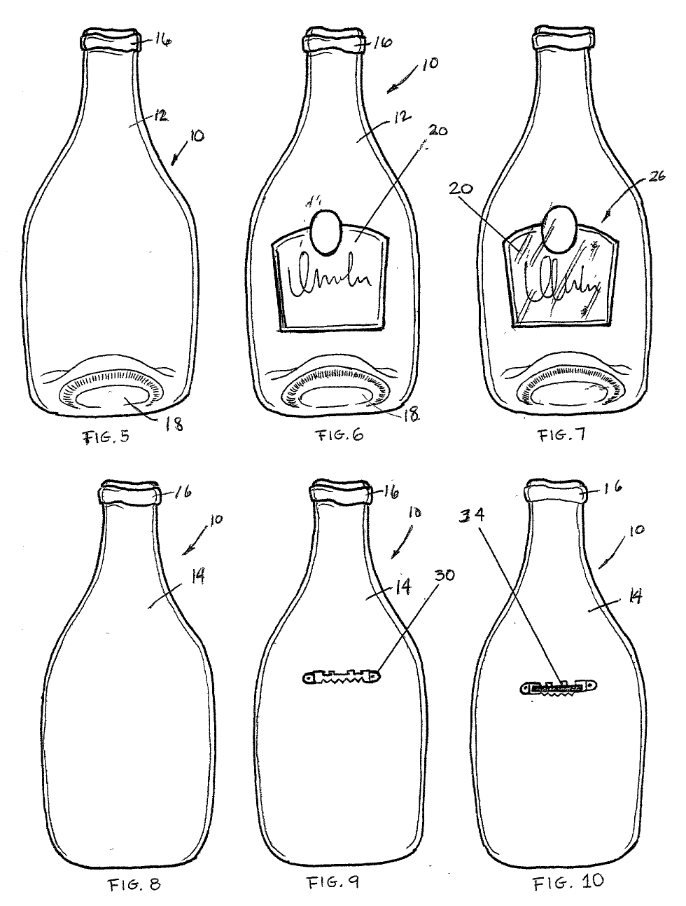

FIGS. 1 through 4 illustrate a conventional glass wine bottle or the like, fabricated in accordance with the method of the present invention. The wine bottle 10 represents a conventional, substantially cylindrical glass bottle which has been slumped so as to be substantially flat, as illustrated in the edge view of FIG. 2, having a flat front surface 12 and a flat back surface 14 formed by the collapsed sidewall of the original bottle. Both the top 16 and the bottom 18 of the bottle are collapsed, but are substantially thicker than the sidewall portion 12 of the bottle. A conventional label 20, which may be identical to a particular vineyard's label for its brand of wine is secured to the front surface 12 of the bottle and is covered by a protective layer, for example, sprayed or brushed acrylic. A suitable support such as a wall hanger 22 is secured, as by a suitable adhesive, to the rear surface 14 of the slumped bottle 10. Preferably, a protective layer such as a layer 24 of felt is provided on the hanger to protect a wall surface or the like on which the bottle 10 may be hung.

As noted above, the provision of a vineyard's proprietary wine label on a slumped bottle, which preferably would be a bottle conventionally used by that vineyard, can be sold in the vineyard's gift store, for example, to enable wine enthusiasts who visit the vineyard to collect souvenirs of its products. Such souvenirs, or gift items, can be used as wall hangings for display, may be used as trivets, cheese trays, spoon rests, or the like, and thus provide to customers souvenirs of their visit as well as providing increased brand awareness and brand loyalty.

The process for fabricating the slumped bottle device described above with respect to FIGS. 1-4 is illustrated in FIGS. 5-10, to which reference is now made. As a first step, a glass bottle, which may be similar to a bottle used for a particular brand or type of wine, is cleaned and is placed in a heating oven such as a standard kiln. The bottle is placed on its side and the kiln is heated to a cone temperature sufficient to cause the bottle to melt and to slump to a flattened configuration. In a conventional small kiln, a bottle may be heated to a Cone 016 temperature, at which time the kiln shuts off and the bottle is allowed to cool. It is found that a suitable cooling time is approximately 7 hours, although this may vary with the type of glass, with the temperature to which it was heated, and like factors.

Following cooling, the bottle is cleaned and a label 20 is affixed to the front surface 12 as illustrated in FIG. 6. Thereafter, a high gloss clear acrylic layer, generally indicated at 26 in FIG. 7, is applied to the label 20 to protect it from deteriorating when the bottle 10 is in use. After the acrylic has cured, the bottle is turned over and, as illustrated in FIGS. 8 and 9, a self-leveling hanger 30, or other suitable support, is affixed to the back surface 14. Finally, as illustrated in FIG. 10, a protective layer, such as a thin layer 34 of cotton felt or the like is affixed to the surface of the self-leveling hanger. This prevents the hanger from scratching any surface it might touch during use.

Although the invention has been described in terms of a preferred embodiment, it will apparent that numerous modifications and variations may be made without departing from the true spirit and scope thereof, as set forth in the following claims.

What is claimed is:

1. A method of making a slumped bottle product, comprising:
heating a glass bottle to cause the bottle to slump;
cooling the slumped bottle; and
affixing a label to a front surface of the slumped bottle.

2. The method of claim 1, further including applying a protective coating to at least the label affixed to said slumped bottle.

3. The method of claim 2, wherein applying a protective coating includes brushing a clear acrylic over said label.

4. The method of claim 2, wherein applying a protective layer includes spraying a clear acrylic over said label.

5. The method of claim 2, further including affixing a support to a back surface of said slumped bottle.

6. The method of claim 5, further including affixing a protective layer to said support.

7. The method of claim 2, further including affixing a self-leveling wall hanger to a back surface of said slumped bottle.

8. The method of claim 1, further including affixing a support to a back surface of said slumped bottle.
